(19) United States
(12) Patent Application Publication
(10) Pub. No.: US 2026/0259374 A1
(43) Pub. Date: Sep. 3, 2026

(54) DEVICE AND METHOD FOR RECONNECTING OPTICAL FIBERS

(71) Applicant: NTT, Inc., Tokyo (JP)

(72) Inventors: Hidenobu HIROTA, Musashino-shi, Tokyo (JP); Kazutaka NOTO, Musashino-shi, Tokyo (JP); Takui UEMATSU, Musashino-shi, Tokyo (JP); Hiroyuki IIDA, Musashino-shi, Tokyo (JP); Kazunori KATAYAMA, Musashino-shi, Tokyo (JP)

(21) Appl. No.: 18/873,366

(22) PCT Filed: Jun. 24, 2022
(86) PCT No.: PCT/JP2022/025258

§ 371 Date: Dec. 10, 2024

(51) Int. Cl. G02B 6/255; G02B 6/245

(52) U.S. Cl. CPC G02B 6/2553; G02B 6/245

(57) ABSTRACT

An object of the present disclosure is to make it possible to reduce the number of devices required for performing a series of operations of switching connection of an optical fiber. The present disclosure is a device including a pair of electrode rods that fusion-splices a glass portion provided in an optical fiber, in which the coating provided in the optical fiber is removed using the pair of electrode rods.

### TECHNICAL FIELD

The present disclosure relates to a device used for switching an optical fiber.

### BACKGROUND ART

In the optical access network, Internet and telephone services are provided to users. When a device constituting the optical access network is replaced, optical fiber switching work is performed from a device that has been originally used to a new device. The optical fiber of the relocation source is used for communication, but in the optical fiber switching work, the coating of the optical fiber is removed, the optical fiber is cut, and fusion splicing is performed (See, for example, Non Patent Literature 2).

The size of one optical fiber is as thin as the outer diameter of the glass portion of 125 μm and the outer diameter of the coating of 250 μm. The thickness is substantially the same as that of one hair. The operator holds the optical fiber having such a minute size in his/her hand and sets the optical fiber in the apparatus to perform the work.

In current construction, a separate device is used for removing a coating of an optical fiber, cutting the optical fiber, and fusion-splicing. When replacing the device, the attention of the operator is diverted from the optical fiber. Furthermore, the work time is not limited to bright daytime hours. Construction may be performed in the rain or snow. The environment in which construction is performed is not necessarily an environment that is easy for the worker. For this reason, the optical fiber may be broken when the device is replaced in the middle of construction. Under such an environment, it is a problem that the construction cannot be completed without a plurality of devices.

### CITATION LIST

### Non Patent Literature

Non Patent Literature 1: The Institute of Electronics, Information and Communication Engineers “Knowledge Base”, Group 5, Volume 2, Chapter 3, p. 1 to 5
Non Patent Literature 2: Tomohiro Konuma, Akito Nishimura, Shoichiro Matsuo, and Kuniharu Himeno, “Basics and Advances on Splicing Technologies of Optical Fibers for Telecommunications”, Laser Research, 2012, Vol. 40, No. 6, p. 435

### SUMMARY OF INVENTION

### Technical Problem

An object of the present disclosure is to make it possible to reduce the number of devices required for performing a series of operations of switching connection of an optical fiber.

### Solution to Problem

A device of the present disclosure is a device for reconnecting an optical fiber, the device including a pair of electrode rods that fusion-splices a glass portion provided in an optical fiber, in which the coating provided in the optical fiber is removed using the pair of electrode rods. For example, in the device of the present disclosure, the pair of electrode rods is switchable between a temperature of 1000° C. or higher and a temperature of 200° C. or higher and lower than 1000° C.

A method of the present disclosure is a method performed by a device of the present disclosure, the method including removing a coating provided in a first optical fiber using the pair of electrode rods, and fusion-splicing a glass portion provided in the first optical fiber and a glass portion provided in the second optical fiber using the pair of electrode rods.

Here, the first optical fiber and the second optical fiber are optical fibers extending from communication buildings disposed at different positions. As described above, the device of the present disclosure can perform the work of switching connection from the first optical fiber to the second optical fiber.

The device of the present disclosure may include an electrode rod movable base that moves the pair of electrode rods in a longitudinal direction of the first optical fiber. In addition, the device of the present disclosure may include an air blower in which the pair of electrode rods melt the coating to remove soot generated by the dissolution of the coating. Furthermore, the device of the present disclosure may include a camera that captures an image of the glass portion exposed by the pair of electrode rods so that whether soot can be removed can be checked.

The method of the present disclosure further includes discharging from the pair of electrode rods parallel to the longitudinal direction of the first optical fiber to remove the coating of the first optical fiber in the longitudinal direction of the first optical fiber, removing soot remaining on a surface by air blowing after removal of the coating of the first optical fiber, and monitoring the glass portion of the first optical fiber exposed by the removal of the coating by a camera.

The device of the present disclosure may include a pressing base that presses the glass portion on a side surface of the glass portion facing a side surface on which the metal blade is disposed, and a metal blade movable portion that moves the metal blade to a surface of the glass portion. As a result, a series of operations of switching connection from the first optical fiber to the second optical fiber can be performed by one device.

Note that the disclosures described above can be combined in any possible manner.

### Advantageous Effects of Invention

The present disclosure can reduce the number of devices required for performing a series of operations of optical fiber switching connection. Therefore, the present disclosure can reduce the construction burden on the worker and improve the work efficiency.

### BRIEF DESCRIPTION OF DRAWINGS

FIG. 1 is a configuration example of an optical access network.

FIG. 2 is a configuration example of an optical fiber.

FIG. 3 is a configuration example of a tape fiber.

FIG. 4 illustrates an example of switching connection of an optical fiber in an optical access network.

FIG. 5 illustrates an example of a work process at a switching point.

FIG. 6 illustrates an example of a coating removal method at a switching point.

FIG. 7 illustrates an example of an optical fiber cutting method at a switching point.

FIG. 8 illustrates an example of an optical fiber fusion method at a switching point.

FIG. 9 is an explanatory view of coating removal by discharge performed by the device of the present disclosure.

FIG. 10 is a side view illustrating an example of a device configuration of the present disclosure.

FIG. 11 is a top view illustrating an example of a device configuration of the present disclosure.

FIG. 12 is an explanatory view of optical fiber cutting performed by the device of the present disclosure.

FIG. 13 is an explanatory diagram of movement of a transfer destination fiber performed by the device of the present disclosure.

FIG. 14 is an explanatory view of fusion-splicing performed by the device of the present disclosure.

### DESCRIPTION OF EMBODIMENTS

Hereinafter, an embodiment of the present disclosure will be described in detail with reference to the drawings. Note that the present disclosure is not limited to the embodiments described below. These examples are merely exemplary, and the present disclosure can be implemented in forms obtained by making various modifications and improvements on the basis of the knowledge of those skilled in the art. Note that components having the same reference signs in the present specification and the drawings indicate the same components.

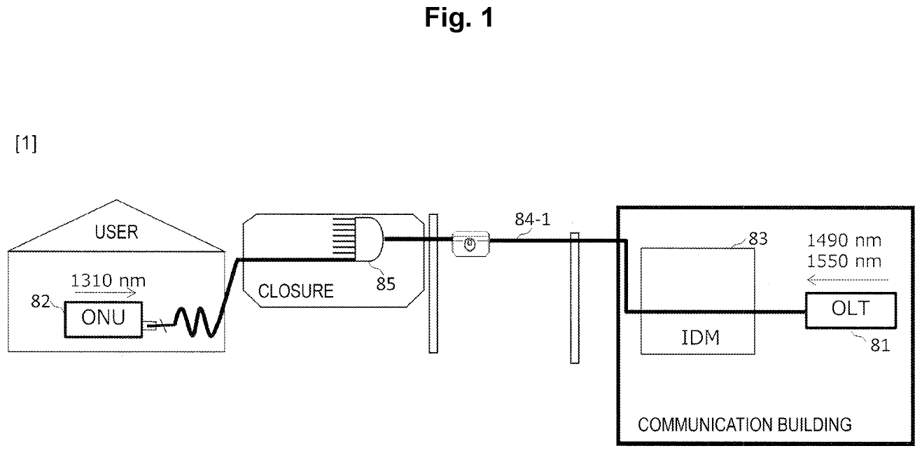

In the optical access network, the facilities illustrated in FIG. 1 are provided to provide the Internet and telephone services to users. An optical line terminal (OLT) 81 which is a communication device is installed in a communication building, and an optical network unit (ONU) 82 is installed in a user's house. The OLT 81 and the ONU 82 are connected using an IDM 83, an optical cable 84-1, and a splitter 85. As communication light, wavelengths of 1490 nm and 1550 nm are output from the OLT 81 side, and a wavelength of 1310 nm is output from the ONU 82 side, so that the OLT 81 and the ONU 82 recognize each other and provide high-speed broadband services such as the Internet and telephone to users.

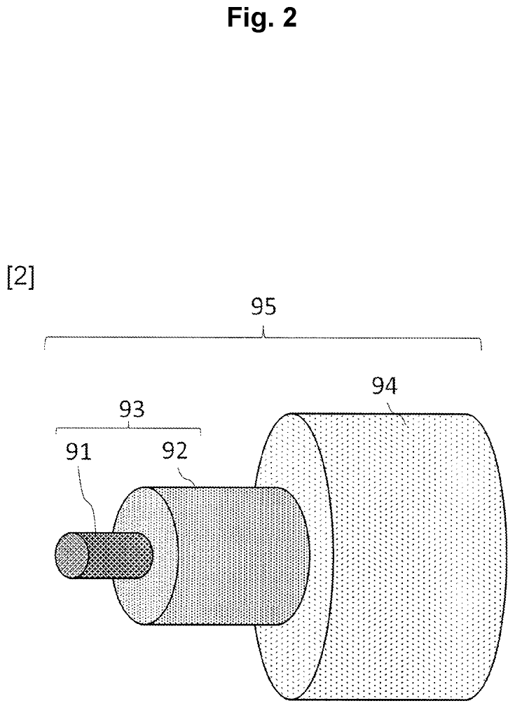

FIG. 2 illustrates a structure of an optical fiber 95 connecting the OLT 81 and the ONU 82. The optical fiber 95 has a three-layer structure of a glass portion 93 formed of a core glass 91 and a cladding glass 92 covering the periphery of the core glass, and a coating 94 for protecting the glass portion 93. The core glass 91 is mainly composed of pure quartz glass, and contains germanium dioxide as an additive. The addition of germanium dioxide increases the refractive index. On the other hand, since the cladding glass 92 is composed of pure quartz glass only, the cladding glass 92 is designed to have a refractive index lower than that of the core glass 91. Since the core glass 91 and the cladding glass 92 have different refractive indexes, total reflection occurs at the boundary surface, and communication light propagates through the core glass 91.

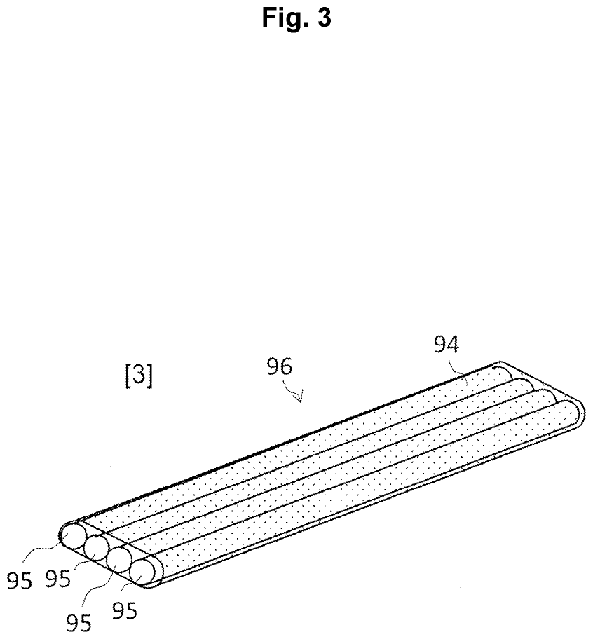

FIG. 3 is an example of a tape fiber 96. The tape fiber 96 is formed by taping two or more optical fibers 95 together. In the present embodiment, the optical cable 84-1 is configured by further bundling the tape fibers 96 in which the four optical fibers 95 are bundled in a tape shape. (Non Patent Literature 1)

Since time has elapsed since the communication building was constructed, the building itself will have deteriorated. For example, as an event, concrete cracks, and moisture enters from the cracks. In the communication building, for example, a large number of communication devices as illustrated in the OLT 81 are installed. Communication equipment is powered by electric power. If moisture enters the communication building and comes in contact with the communication device, it is conceivable that the moisture will affect the device and at worst it. That is, the service cannot be provided to the user.

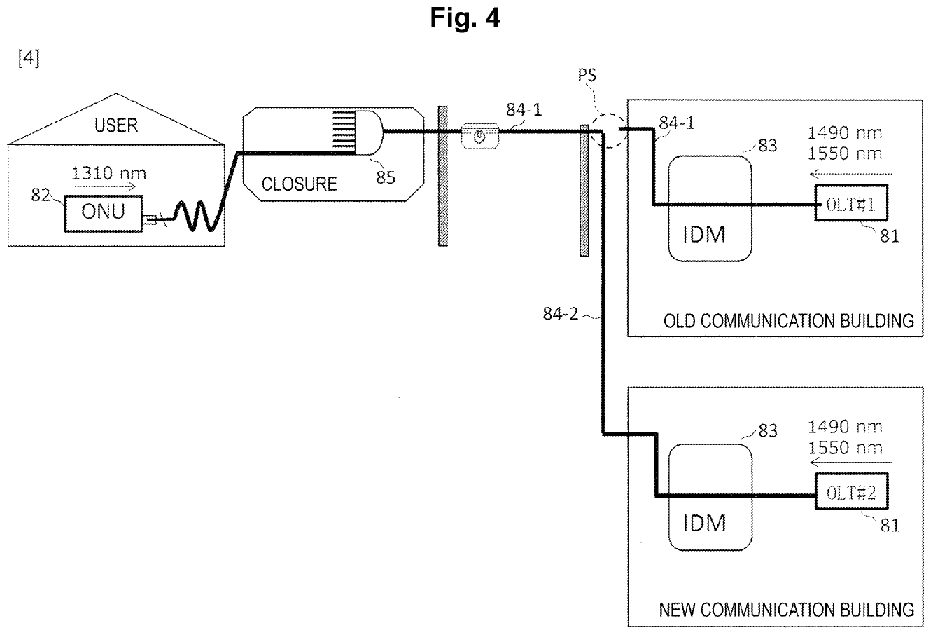

Therefore, as a countermeasure, as illustrated in FIG. 4, it is desired to construct a new communication building, install a new OLT 81#2 in the new communication building, and provide a service by an optical signal from the OLT 81#2. For this purpose, it is necessary to cut the optical cable 84-1 extending from the OLT 81#1 and switch to a new optical cable 84-2.

A procedure of switching from the old communication building (OLT 81#1) to the new communication building (OLT 81 #2) is as follows.

First, as preparation, the optical cable 84-1 to be cut is confirmed. At this time, communication between the OLT 81#1 and the ONU 82 is maintained.

In the next step, the optical cable 84-1 connecting the OLT 81#1 and the ONU 82 is disconnected. Naturally, communication stops.

Thereafter, the optical cable 84-2 is fusion-spliced to the optical cable 84-1, and the OLT 81#2 and the ONU 82 are communicative connected.

Finally, since the communication between the OLT 81#2 and the ONU 82 starts, it is confirmed that the communication has started.

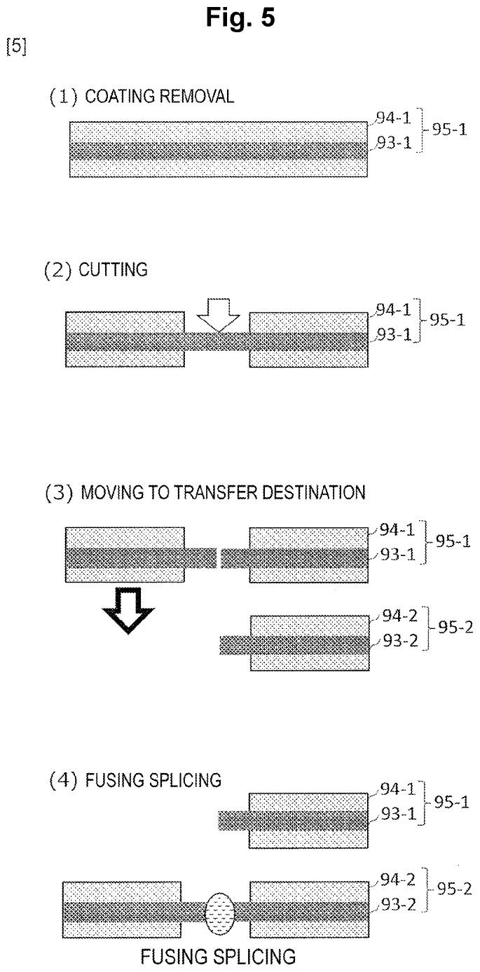

FIG. 5 illustrates a work process at the switching point PS. In order to perform the switching, the optical fiber 95 is cut and connected, and the process will be described in detail.

### (1) First Step

The optical fiber 95-1 is covered with a coating 94-1 in order to protect a glass portion 93-1. Therefore, the coating 94-1 of the optical fiber 95-1 is removed. In order to remove the coating 94-1, a coating removal apparatus serving as a dedicated tool is required. Glass appears when the coating 94-1 is removed.

### (2) Second Step

A blade is brought into contact with the glass portion 93-1 to perform cutting. Also at the time of cutting, a fiber cutter serving as a dedicated tool is required.

### (3) Third Step

The movement of the optical fiber 95-2 to be relocated, that is, the optical fiber 95-2 of the optical cable 84-2 extending from the new communication building is connected to the optical fiber 95-1 of the optical cable 84-1 to be relocated.

### (4) Fourth Step

Then, the optical fibers 95-1 and 95-2 are connected using a fusion splice device as a dedicated tool.

### (5) Fifth Step After the connection, communication between the OLT 81#2 and the ONU 82 is started.

As described above, in order to perform optical fiber switching, a plurality of processes such as coating removal, cutting, movement of a fiber to be relocated, and fusion splicing are required, and a coating removal apparatus, a fiber cutter, and a fusion splice device are required.

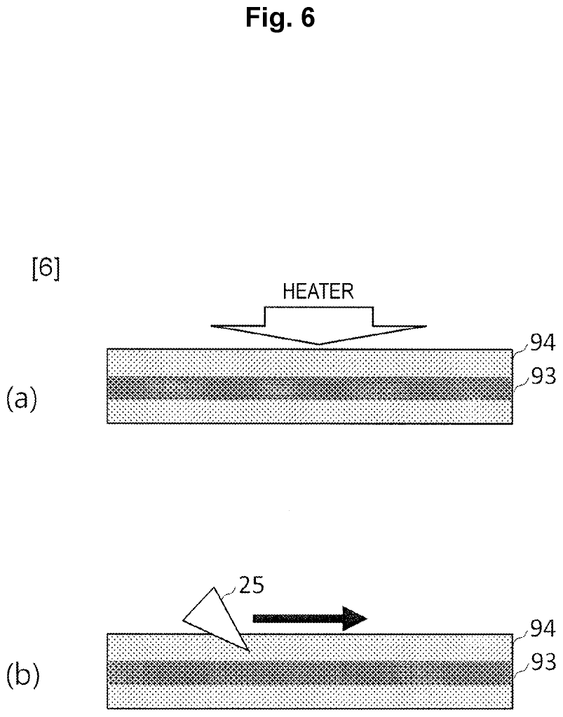

FIG. 6 is an explanatory diagram of the coating removal apparatus currently used. As illustrated in FIG. 6(a), the coating 94 is softened by applying a heater to the surface of the coating 94. Thereafter, as illustrated in FIG. 6(b), a blade 25 made of metal or the like is brought into contact with the softened coating 94, and the blade 25 is moved in parallel with the longitudinal direction of the optical fiber 95. Thus, the coating 94 can be peeled off.

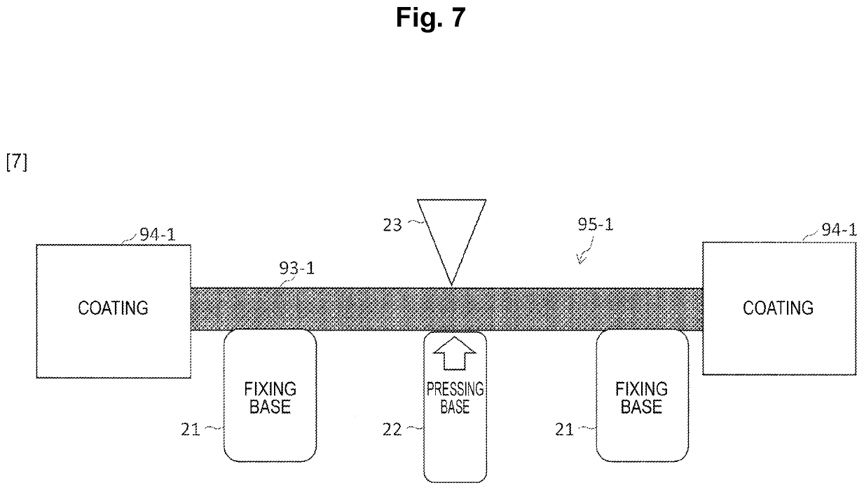

FIG. 7 is an explanatory diagram of a fiber cutter currently used. Both ends of the glass portion 93-1 are installed on a fixing base 21. When a pressing base 22 is moved in the upward direction from the bottom, the glass portion 93-1 is sandwiched between the metal blade 23 and the pressing base 22. By moving the metal blade 23 perpendicular to the longitudinal direction of the glass portion 93-1, the metal blade 23 is brought into contact with the glass portion 93-1, and the glass portion 93-1 is scratched. Since the pressure from the pressing base 22 is applied, the damaged glass portion 93-1 is cracked, and the optical fiber 95-1 is cut.

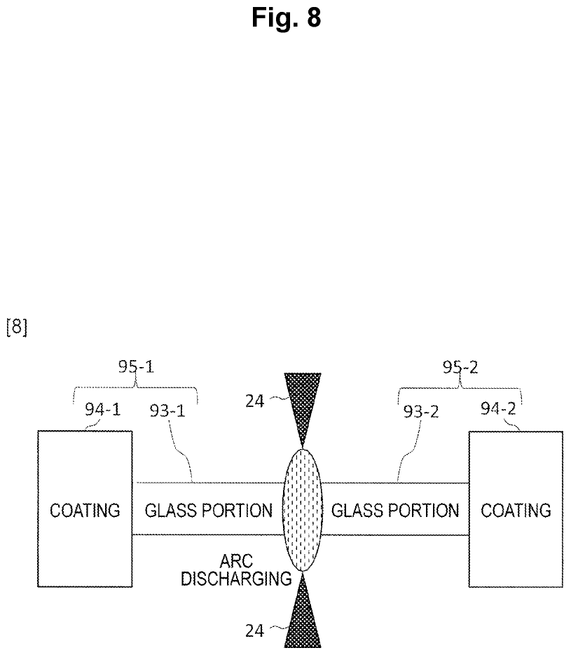

FIG. 8 is an explanatory diagram of a fusion splice device currently used. The glass portions 93-1 and 93-2 of the tape fibers are disposed to face each other and aligned with high accuracy. Thereafter, the electrode rod 24 is discharged to melt the glass portions 93-1 and 93-2, thereby connecting the optical fibers to each other.

In current construction, a coating removal apparatus, a fiber cutter, and a fusion splice device are used to connect optical fibers. The work time is not limited to the bright daytime. Construction may be performed in the rain or snow. The environment in which construction is performed is not necessarily an environment that is easy for the worker. It is a problem that the work is not completed unless the thin optical fiber is installed in the device without being damaged and the device is operated each time the work is performed while replacing the plurality of devices under such an environment. Therefore, the present disclosure proposes a device that reduces a construction burden on a worker.

### Outline of Present Disclosure

In the example of FIG. 6, it has been described that the coating 94-1 is scraped using the metal blade 25 in order to remove the coating 94-1. However, the fusion splice device has a discharge function, and the coating 94-1 can be dissolved by using the discharge. Therefore, in the present disclosure, the removal of the coating 94 is concentrated in the fusion splice device by performing the discharge function.

In addition, the metal blade 23 and the pressing base 22 provided in the fiber cutter have a small number of components and a small component size. Therefore, in the present disclosure, the fiber cutter may be accommodated in the housing of the fusion splice device.

Hereinafter, specific functions and operations provided in the device of the present disclosure will be described in detail.

### Embodiment 1

In the device of the present embodiment, the coating 94 is dissolved and removed by discharge using discharge generated by the electrode rod. In order to melt the glass in the fusion splicing, 1300° C. or higher is required.

On the other hand, the coating 94 is made of an organic material, and a typical material is an ultraviolet curable resin. The ultraviolet curable resin is easily dissolved when heated to 200° C. Therefore, by applying coating removal using discharge, it is possible to eliminate a coating removal apparatus that has been conventionally required. By setting the temperature for removing the coating to 200° C. to 1000° C., only the coating can be removed without melting the glass.

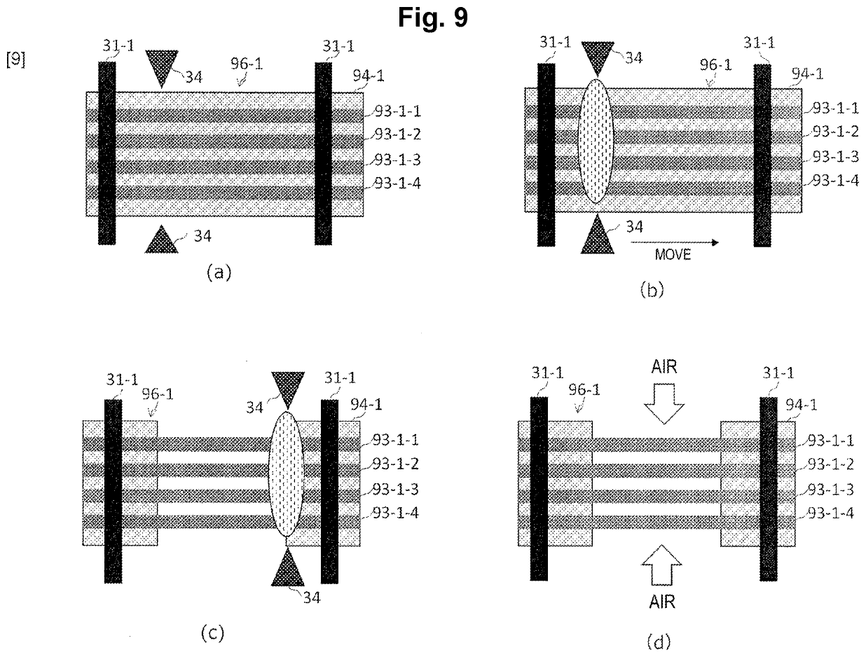

FIG. 9 illustrates a configuration example for removing the coating 94 using discharge. In the drawing, an example is illustrated in which the optical cable 84-1 is a tape fiber 96-1 including four glass portions 93-1-1 to 93-1-4.

Two fixing members 31 are used to fix the tape fiber 84-1, and an electrode rod 34 is moved to the vicinity of the tape fiber (FIG. 9(a)).

Next, the electrode rod 34 is moved along optical cable 84-1 while discharging the electrode rod 34 (FIG. 9(c)). As a result, a part of the coating 94 in the longitudinal direction of the optical cable 84-1 can be removed.

Here, although only the coating 94 is removed due to the high temperature, a part of the coating 94 may become soot and remain on the surface of the glass portion 93. In order to remove the soot, air is jetted to the exposed portion of the glass portion 93 and dropped (FIG. 9(d)).

Finally, whether the coating 94 has been removed is confirmed using a camera. If the coating 94 remains, discharging and air blowing are performed again and repeated until soot falls.

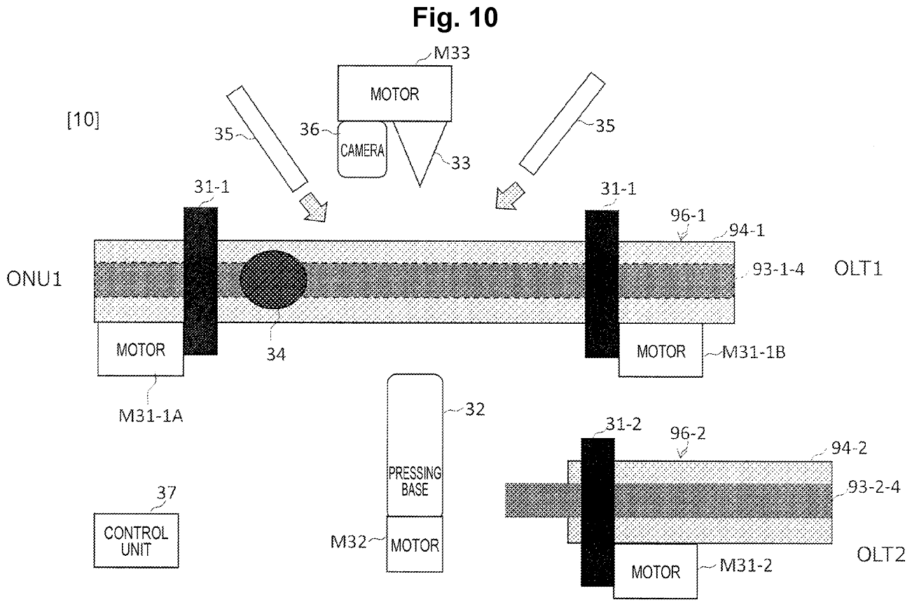

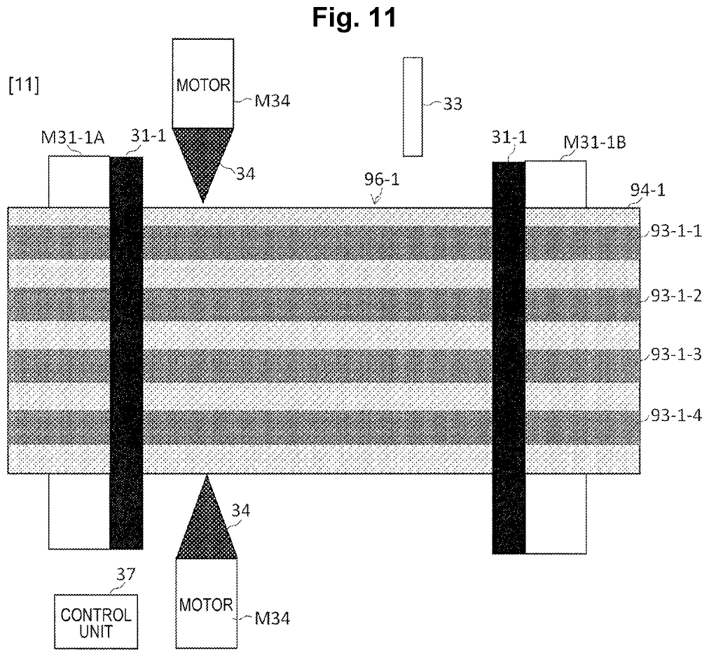

FIGS. 10 and 11 illustrate an example of a device configuration of the present disclosure. FIG. 10 is a side view, and FIG. 11 is a top view. The device of the present disclosure includes a fixing member 31, a metal blade 33, a pressing base 32, an electrode rod 34, an air blow 35, a camera 36, and a control unit 37. In addition, the device of the present disclosure includes motors M31-1A, M31-1B, M33, M32, and M34 that function as movable portions of the fixing members 31-1 and 31-2, the metal blade 33, the camera 36, the pressing base 32, and the electrode rod 34, respectively. The motor M32 functions as a pressing base movable portion that moves the pressing base 32 to the surface of the glass portion 93-1. The motor M33 functions as a metal blade movable portion that moves the metal blade 33 to the surface of the glass portion 93-1. The motor M34 functions as an electrode rod movable portion that moves the electrode rod 34 in the longitudinal direction of the tape fiber 96-1.

The control unit 37 controls an arbitrary operation in the device of the present disclosure. For example, the control unit 37 switches the temperature of the electrode rod 34 between a temperature of 1000° C. or higher for performing fusion splicing and a temperature of 200° C. or higher and lower than 1000° C. for removing a coating. The temperature may be manually switched by the user, or may be automatically switched by the control unit 37.

In the device of the present disclosure, the connection from the tape fiber 96-1 to the tape fiber 96-2 can be automatically changed. In the case of automatic operation, the user installs the tape fibers 96-1 and 96-2 in the device of the present disclosure and presses a start button provided in the apparatus of the present disclosure. Then, the control unit 37 controls an arbitrary functional unit included in the device of the present disclosure to automatically execute the coating removal of the tape fiber 96-1, the cutting of the tape fiber 96-1, the movement of the tape fiber 96-1 or 96-2, and the fusion splicing of the tape fibers 96-1 and 96-2 in order.

### Installation of Optical Fiber in Device of Present Disclosure

The fixing member 31-1 linearly fixes the tape fiber 96-1 at the center in the device. Both ends of the linear tape fiber 96-1 are connected to the ONU 82 and the OLT 81#1 illustrated in FIG. 4. The fixing member 31-2 disposed on the lower side of the fixing member 31-1 fixes the tape fiber 96-2 to be reconnected. At the tip of the tape fiber 96-2, the coating 94-2 has already been removed, and the glass portions 93-2-1 to 93-2-4 are exposed. The tape fiber 96-2 extends to the OLT 81#2.

### Optical Fiber Cutting

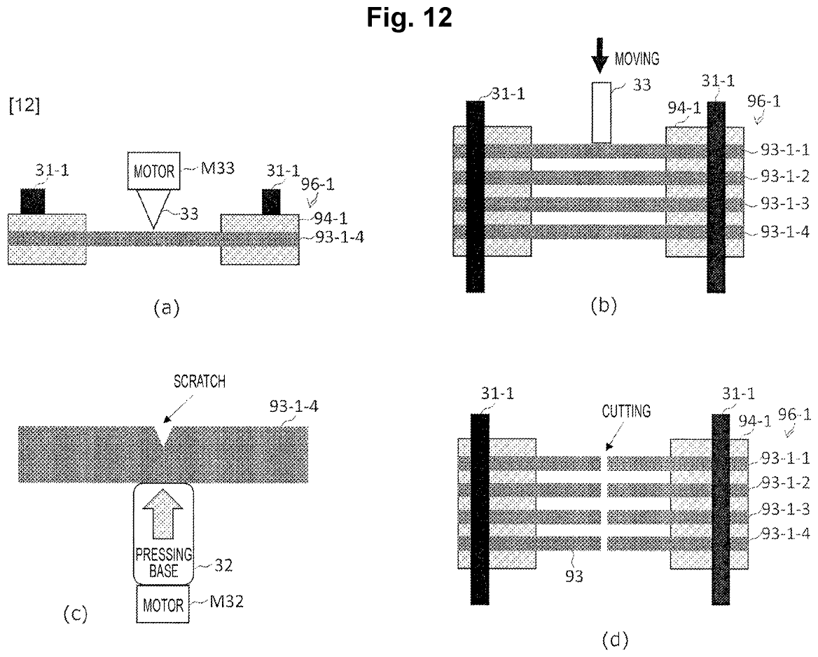

FIG. 12 illustrates a method of cutting an optical fiber by the device of the present disclosure. FIG. 12(a) and 12(c) illustrate cross-sectional views, and FIG. 12(b) and 12(d) illustrate top views. The metal blade 33 and the pressing base 32 are provided with the motors M33 and M32 for adjusting positions.

After the coating 94-1 due to the discharge is removed, as illustrated in FIG. 12(a) and (b), the position of the metal blade 33 is adjusted using the motors M33 and M32 such that the metal blade 33 comes into contact with the surface on the glass portion 93-1.

Next, the metal blade 33 comes into contact with the surface of the glass portion 93 to make a scratch. At this time, by moving the metal blade 33 perpendicular to the longitudinal direction of the glass portion 93-1 (FIG. 12(b)), the surfaces of the glass portions 93-1-1 to 93-1-4 are scratched.

Thereafter, the pressing base 32 on the lower side of the tape fiber 96-1 is moved upward by the motor M32 to press the tape fiber 96-1. Since there are already scratches on the surfaces of the glass portions 93-1-1 to 93-1-4, the glass portions 93-1-1 to 93-1-4, that is, the tape fiber 96-1 is cut from the scratches.

### Movement of Optical Fiber to Transfer Destination

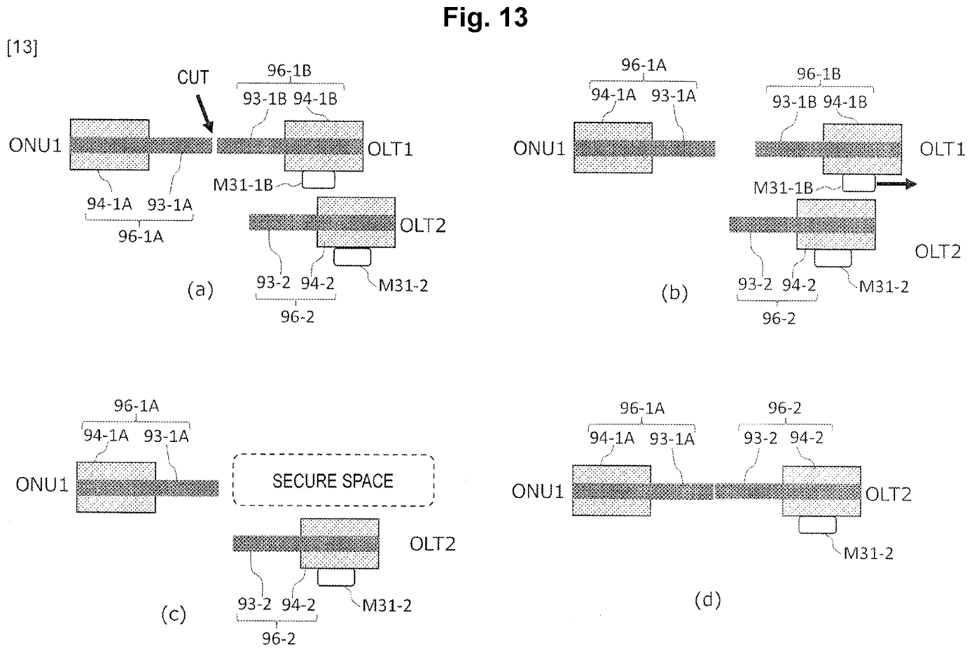

After the tape fiber 96-1 is cut, the OLT 81#1 is switched to the OLT 81#2 as illustrated in FIG. 13.

First, as illustrated in FIG. 13(a), the motor M31-2 disposes the tape fiber 96-2 of the OLT 82-#2 extending from the new communication building below the tape fiber 96-1B from the OLT 82#1 extending from the old communication building.

Next, since it is desired to connect the tape fiber 96-2 on the OLT 82#2 side and the optical fiber 96-1A of the ONU 82, as illustrated in FIG. 13(b), the motor M31-1B lowers the tape fiber 96-1B on the OLT 81#1 side backward. As a result, as illustrated in FIG. 13(c), a space is formed at the position of the tape fiber 96-1B.

Next, as illustrated in FIG. 13(d), the motor M31-2 moves the tape fiber 96-2 extending from the OLT 81#2 to the space. Further, the motor M31-2 aligns the tape fiber 96-2 extending from the OLT 81#2 with the tape fiber 96-1B with high accuracy.

Although the example in which the tape fiber 96-1B is lowered backward has been described above, the same effect can be obtained by a method of laterally shifting the tape fiber. In addition, the same effect can be obtained by installing the motor M31-1A on the ONU 82 side and moving the tape fiber 96-1A up and down.

Finally, the motor M34 moves the electrode rod 34 to the alignment of the tape fibers 96-1B and 96-2 in FIG. 13(d). Then, the electrode rod 34 discharges. As a result, the end surfaces of the glass portions 93-1-1 to 93-1-4 of the tape fiber 96-1B and the glass portions 93-2-1 to 93-2-4 of the tape fiber 96-2 can be fusion-spliced.

### Removal of Coating of Optical Fiber and Fusion Splicing

The electrode rod 34 has two functions of coating removal and fusion splicing. The method of removing the coating is as described in FIG. 9. In the present embodiment, the electrode rod 34 discharges from the horizontal direction of the glass portions 93-1-1 to 93-1-4 and the glass portions 93-2-1 to 93-2-4.

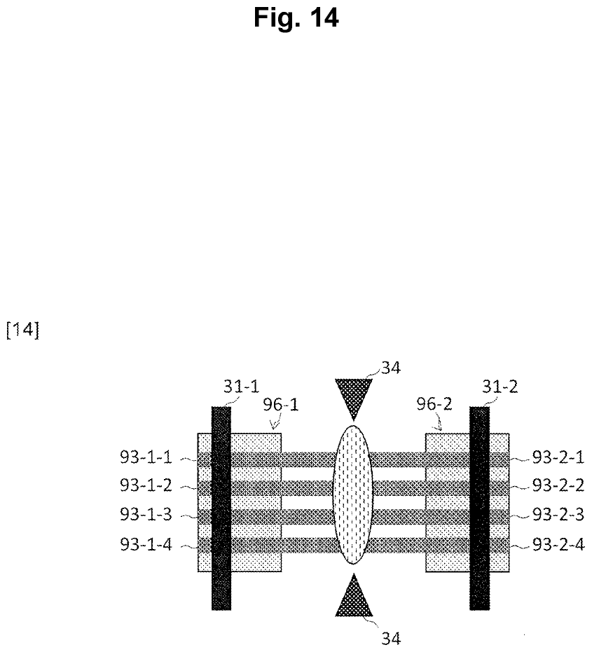

Similarly to the removal of the coating, as illustrated in FIG. 14, the fusion splicing of the glass portions 93-1-1 to 93-1-4 and the glass portions 93-2-1 to 93-2-4 is performed by discharging from the horizontal direction. At this time, the motor M34 moves the electrode rod 34 to the connection position between the glass portions 93-1-1 to 93-1-4 and the glass portions 93-2-1 to 93-2-4.

Here, the device of the present disclosure includes a motor M34 that moves the electrode rod 34 in the longitudinal direction of the tape fiber 96-1 as illustrated in FIG. 9(b) in order to perform coating removal. As a result, by discharging from the electrode rod 34 in parallel with the longitudinal direction of the tape fiber 94-1, a part of the coating 94-1 can be removed in the longitudinal direction of the tape fiber 94-1. In the present embodiment, an example in which the motor M34 is arranged at the subsequent stage of the electrode rod 34 will be described.

In addition, the air blow 35 for removing soot of the coating 94-1 after discharging and a camera 36 for confirming the state of the glass portion 93-1 are provided. Since the camera 36 can be seen in a wider range when photographed from the upper surface of the coating 94-1, it may be fixed to the same motor M33 as the metal blade 33. Further, by disposing the camera 36 on the upper side, the alignment of the tape fibers 96-1A and 96-2 described in FIG. 13 can be visually recognized by the camera 36.

As described above, in the present disclosure, functions of coating removal, cutting, movement of a fiber to be relocated, and fusion splicing can be incorporated into one device. Furthermore, the device of the present disclosure includes the control unit 37 that sequentially executes operations of coating removal, cutting, movement of the transfer destination fiber, and fusion splicing. As a result, the device of the present disclosure can perform a series of operations of switching connection of the optical fiber with one switch after the tape fiber 96-1 is fixed to the fixing portion 31-1 and the tape fiber 96-2 is fixed to the fixing portion 31-2.

### Obtained Effects

By integrating the functions into one device, it is possible to easily switch the optical fiber only by a simple operation of pressing the switch. As described in the background, this work is performed outdoors in a dark place, a cold place, or a rainy place, and the worker needs to have a skill because a plurality of devices are used. In the method according to the present invention, since one device is provided and the device operates with one switch, the skill level required of the worker can be lowered (anyone can work). Although the population of Japan is decreasing and there is a shortage of people in any industry, it can also contribute to solving the problem.

### Reference Signs List

21 Fixing base
22 Pressing base
23, 25 Blade
24 Electrode rod
31-1, 31-2 Fixing member
32 Pressing base
33 Metal blade
34 Electrode rod
35 Air blow
36 Camera
37 Control unit
81 OLT
82 ONU
83 IDM
84-1, 84-2 Optical cable
85 Splitter
91 Core glass
92 Cladding glass
93, 93-1, 93-1-1, 93-1-2, 93-1-3, 93-1-4, 93-2, 93-2-1, 93-2-2, 93-2-3, 93-2-4 Glass portion
94, 94-1, 94-2 Coating
95, 95-1, 95-2 Optical fiber
96, 96-1, 96-2 Tape fiber

1. A device comprising:
a pair of electrode rods configured to fusion-splice a glass portion provided in an optical fiber, wherein
the coating provided in the optical fiber is removed using the pair of electrode rods.

2. The device according to claim 1, further comprising:
an electrode rod movable portion configured to move the pair of electrode rods in a longitudinal direction of the optical fiber.

3. The device according to claim 1, wherein
the pair of electrode rods is configured to dissolve the coating, the device further comprising:
an air blow for removing soot generated by dissolution of the coating; and
a camera configured to capture an image of the glass portion exposed by the pair of electrode rods.

4. The device according to claim 1, wherein
the pair of electrode rods is switchable between a temperature of 1000° C. or higher and a temperature of 200° C. or higher and lower than 1000° C.

5. The device according to claim 1, further comprising:
a metal blade configured to scratch the glass portion;
a pressing base configured to press the glass portion on a side surface of the glass portion facing a side surface on which the metal blade is disposed;
a metal blade movable portion configured to move the metal blade to a surface of the glass portion; and
a pressing base movable portion configured to move the pressing base to a surface of the glass portion.

6. A method performed by a device including a pair of electrode rods, the method comprising:
removing a coating provided in a first optical fiber using the pair of electrode rods; and
fusion-splicing a glass portion provided in the first optical fiber and a glass portion provided in the second optical fiber using the pair of electrode rods.

7. The method according to claim 6, further comprising:
discharging from the pair of electrode rods in parallel with the longitudinal direction of the first optical fiber to remove a part of the coating of the first optical fiber in the longitudinal direction of the first optical fiber;
removing soot remaining on a surface by air blowing after removal of the coating of the first optical fiber; and
monitoring the glass portion of the first optical fiber exposed by the removal of the coating by a camera.

8. The method according to claim 6, wherein
the first optical fiber and the second optical fiber are optical fibers extending from communication buildings disposed at different positions.
